(19) United States
(12) Patent Application Publication
(10) Pub. No.: US 2026/0297763 A1
(43) Pub. Date: Oct. 1, 2026

(54) METHOD AND PLANT FOR PRODUCING HYDROGEN

(71) Applicant: Linde GmbH, Pullach (DE)

(72) Inventors: Marius DILLIG, Pullach (DE); Florian WINKLER, Pullach (DE)

(21) Appl. No.: 19/476,921

(22) PCT Filed: Mar. 27, 2024
(86) PCT No.: PCT/EP2024/025133

§ 371 Date: Oct. 20, 2025

(30) Foreign Application Priority Data
Apr. 20, 2023 (EP) 23020190.7

(51) Int. Cl. C25B 1/044; B01D 53/26; B01D 53/86; C25B 15/08

(52) U.S. Cl. CPC C25B 1/044; B01D 53/261; B01D 53/86; C25B 15/081; C25B 15/083; B01D 2256/16; B01D 2257/104; B01D 2257/80

(57) ABSTRACT

A method for producing hydrogen, where feed water is subjected to electrolysis with a cathode gas being obtained, wherein the cathode gas contains hydrogen, oxygen and some of the feed water, wherein a process gas flow (102) is formed using at least some of the cathode gas, where the process gas flow contains at least some of the hydrogen, oxygen and feed water contained in the cathode gas, and where, in the process gas flow, at least some of the oxygen is subjected to an oxidative catalytic reaction with some of the hydrogen to form oxidation water, and where at least some of the feed water and the oxidation water in the process gas flow are removed from the process gas flow in a water removal process.

The invention relates to a method and to a plant for producing hydrogen.

### BACKGROUND OF THE INVENTION

Hydrogen production on an industrial scale is currently based mainly on hydrocarbons and comprises, for example, steam reforming of natural gas. Instead of a repeated explanation of what is already known, reference is made to relevant technical literature, such as the articles “Gas Production, 2. Processes” and “Hydrogen, 2. Production” in Ullmann's Encyclopedia of Industrial Chemistry (2012).

Water electrolysis is increasingly being used to produce hydrogen in order to use electricity generated from renewable sources and reduce carbon dioxide emissions. Oxygen can also be produced by water electrolysis. Corresponding methods are explained in more detail below.

In corresponding electrolysis methods, a water-saturated gas flow is typically provided on the cathode side at moderate temperatures and pressures, which gas flow, in addition to hydrogen as the main component, can also contain considerable amounts of oxygen. To remove the oxygen, a catalytic reaction, commonly referred to as CatOx, can be provided.

In certain cases, catalytic conversion may prove to be limiting or disadvantageous in terms of operational flexibility and other aspects. There is therefore a need for methods in which the catalytic conversion can be carried out in a manner that is advantageous compared to the prior art.

### DISCLOSURE OF THE INVENTION

Against this background, a method and a system for producing hydrogen with the features of the independent claims are proposed. Embodiments are the subject matter of the dependent claims and of the following description.

Prior to explaining the features and advantages of the present invention, some of the principles of the present invention will be explained in greater detail, and some of the terms used in the description of the invention will be defined.

In traditional water electrolysis, an aqueous alkaline solution, typically of potassium hydroxide, is used as the electrolyte (AEL, alkaline electrolysis). Electrolysis is carried out with a unipolar or bipolar electrode arrangement at atmospheric pressure or—on an industrial scale—significantly higher. More recent developments in water electrolysis include the use of proton-conducting ion exchange membranes (SPE, solid polymer electrolysis; PEM, proton exchange membranes), wherein the water to be electrolyzed is supplied on the anode side. Electrolysis using anion exchange membranes (AEM) is also known.

The methods mentioned are low-temperature methods in which the water to be electrolyzed is present in the liquid phase. In addition, so-called steam electrolysis is also used, which can likewise be carried out with alkaline electrolytes (i.e., as AEL) with adapted membranes, for example polysulfone membranes, and using solid oxide electrolysis cells (SOEC). The latter comprise in particular doped zirconium dioxide or oxides of other rare earths which become conductive at higher temperatures.

The term electrolysis will be used to refer to all of these methods. Low-temperature electrolysis (PEM, AEL, AEM) in particular is suitable for flexible operation, which supports the energy transition to renewable energies. All methods can be used in the invention as long as the problems addressed by the invention occur.

In the electrolysis methods mentioned, electrolysis devices can be used which have a plurality of electrolysis cells, wherein the electrolysis cells can in particular be part of one or more electrolysis cell stacks of a known type. In corresponding electrolysis cell stacks, typically identical components are provided, in particular anodes, cathodes and separators. The electrolysis cell stacks are connected in particular fluidically in parallel. This provides feed-in or collecting lines that supply the electrolysis cell stack(s) as a whole. Several cell stacks can also be present in a corresponding electrolysis device.

A gas mixture referred to here as cathode gas is understood to mean the gas taken from the cathode side of the cell stack(s) in whole or in part. As mentioned, this is typically water-saturated and exists at elevated pressure and elevated temperature.

During electrolysis, pure hydrogen is not produced as a cathode gas. Rather, this water, which is saturated with water at the typically prevailing 50 to 80° C. and 10 to 40 bar overpressure, contains additional oxygen. The amount of oxygen in the cathode gas depends on the pressure difference between the hydrogen side and the oxygen side and the load (current density) of the electrolyzer. In alkaline electrolysis, it can exceed 1,000 vppm (parts per million by volume) in the hydrogen or the parts formed from hydrogen and oxygen, and in water electrolysis using proton exchange membranes, it is typically in the range of 100 vppm oxygen. To purify the cathode gas from both impurities (water and oxygen), the aforementioned catalytic oxidation and subsequent drying are generally required.

To avoid liquid water on the catalyst, a preheater is conventionally required to heat the cathode gas to at least 15 K above the dew point on the catalyst. The oxygen is then converted into water in the presence of hydrogen on the catalyst.

In the following, the water coming from the electrolysis and fed in with the feed is referred to as feed water, and the water formed oxidatively on the catalyst is referred to as oxidation water. It is understood that the feed water contained in the cathode gas represents only a small part of the total water supplied to the electrolysis process.

Conventionally, after the cathode gas is cooled to typically 10 to 50° C., a portion of the water contained (feed water and oxidation water together) is condensed, separated and discharged. The resulting flow, which is low in oxygen and water, is fed to an adsorption-based dryer. The final product can then be compressed to the desired pressure or passed on to downstream applications.

During dynamic hydrogen production, the temperatures of the catalytic bed must be maintained in standby mode to avoid water condensation and catalyst damage when the plant is restarted. This causes additional effort and/or limits dynamic operation because standby heating of the reactor or additional time for the temperature ramp in the catalytic bed is required. The present invention solves these problems by providing a catalytic layer or bed within the mentioned drying beds.

This proposes a method for producing hydrogen, wherein feed water is subjected to electrolysis to obtain a cathode gas, wherein the cathode gas contains hydrogen, oxygen and some of the feed water. Using at least some of the cathode gas, a process gas flow is formed which contains at least some of the hydrogen, oxygen and feed water contained in the cathode gas, wherein in the process gas flow at least some of the oxygen is subjected to an oxidative catalytic conversion with some of the hydrogen to form oxidation water, and wherein the feed water and the oxidation water in the process gas flow are at least partially removed from said flow in a water removal process.

The term “formation of the process gas flow” is intended to express in particular that, within the scope of the present invention, a certain processing of the cathode gas, for example, as explained below, a cooling and condensing out of water, can be provided, and that not all of the cathode gas has to be used accordingly. However, the process gas flow may also comprise the entire cathode gas in substantially untreated or unseparated form.

The catalytic conversion and the water removal process are carried out in the proposed method using one or more process units, wherein the one process unit or each of the several process units comprises a first adsorptive drying bed, by means of which at least some of the feed water is removed from the process gas flow, a catalytic bed arranged downstream of the first drying bed, by means of which the catalytic conversion is carried out, and a second adsorptive drying bed arranged downstream of the catalytic bed, by means of which at least some of the oxidation water is removed from the process gas flow.

A “bed” as understood here means an arrangement of particles or carrier bodies; in the case of an adsorptive drying bed in particular a bed or other arrangement of particulate adsorption material of any type, and in the case of a catalytic bed in particular a bed of catalyst carrier bodies of any type.

It has been found within the scope of the present invention that a catalytic bed interposed between corresponding drying beds within, for example, adsorption dryers is particularly effective due to the dry operating conditions of the catalyst. Additional drying material downstream of the catalytic bed ensures that the oxidation water formed by the oxidation reaction of oxygen with hydrogen can be reliably removed. Furthermore, the proposed method does not require a separate reactor for the catalytic conversion upstream of the dryers, and no preheating above the dew point of the water in the hydrogen or heating of the reactor used for the catalytic conversion is necessary. This has a particularly positive impact on the dynamic operability of a corresponding plant as well as its construction and operating costs.

In embodiments of the present invention, it can be provided in particular that the process gas flow is supplied to the one or more process units at a feed temperature level of 10 to 50° C. and in particular at a feed pressure level of 10 to 40 bar above atmospheric pressure. In particular, with an appropriate feed temperature level, a portion of the feed water can be separated upstream.

Therefore, embodiments of the present invention provide in particular that the formation of the process gas flow comprises cooling the cathode gas or a portion thereof from a temperature level of between 50 and 80° C. to the feed temperature level and condensative separation of water. As mentioned, the process gas flow in an electrolysis can be provided in particular in a water-saturated form.

In particular, the present invention may comprise, in embodiments, that the process gas flow is provided with an oxygen content of 20 to 500 parts per million by volume. The catalytic removal of oxygen is exothermic and produces water. This circumstance affects the size and requirement of the drying material downstream of the catalytic layer. Particular advantages are achieved here at low oxygen concentrations.

In the context of the present invention, the electrolysis can be carried out in particular as an alkaline electrolysis or can comprise such an electrolysis and/or the electrolysis can be carried out as an electrolysis using a proton exchange membrane or can comprise such an electrolysis. In particular, the particularly favorable low oxygen contents mentioned above can be achieved by means of electrolysis with a proton exchange membrane.

In embodiments of the present invention, at least two of the process units can be provided, through which the process gas flow or parts thereof flow cyclically, as is known per se in adsorbers or dryers, for example in so-called prepurification units of air separation plants.

In corresponding drying processes, use is made of the temperature dependence of adsorption processes. In these processes, an adsorbent which is accommodated in a suitable adsorber container is flowed through in an operating phase at a lower temperature level with the process gas flow to be dried and is thereby loaded with the water from the process gas flow. In a subsequent operating phase, the adsorbent can then be largely freed of the water again by heating, i.e., introducing thermal energy, and can be “regenerated” in this manner. At least two adsorption units are therefore required for the continuous operation so that one can always be flowed through by the gas mixture flow to be separated and can thus be used for separating the gas mixture flow. The same applies to the process units proposed here with an additional catalytic bed.

Within the scope of the present invention, the first drying bed and the second drying bed can each comprise a material designed for adsorption drying. The materials can be the same or different.

In embodiments of the present invention, the water content in the process gas flow can be reduced to a content of less than 100 parts per million by volume by means of the first drying bed, whereby the subsequent catalytic conversion is particularly advantageous and effective.

The proposed plant for producing hydrogen is configured to subject feed water to electrolysis to obtain a cathode gas, wherein the cathode gas contains hydrogen, oxygen and some of the feed water. The plant is further configured to form a process gas flow using at least some of the cathode gas, which comprises at least some of the hydrogen, oxygen, and feed water contained in the cathode gas, and to subject at least some of the oxygen with some of the hydrogen to an oxidative catalytic conversion to form oxidation water. The plant is further configured to remove at least some of the feed water and at least some of the oxidation water in the process gas flow from the process gas flow in a water removal process.

The proposed plant is configured to carry out the catalytic conversion and the water removal using one or more process units, wherein the one process unit or each of the several process units comprises a first adsorptive drying bed, which is configured to remove at least some of the feed water from the process gas flow, a catalytic bed arranged downstream of the first drying bed, which is configured to carry out the catalytic conversion, and a second adsorptive drying bed arranged downstream of the catalytic bed, which is configured to remove at least some of the oxidation water from the process gas flow.

For further features and advantages of a corresponding system and embodiments thereof, reference is expressly made to the above explanations relating to the process proposed according to the invention and its embodiments, since they apply in the same way here.

The same also applies to a system which, according to one embodiment of the invention, is configured to carry out a process according to any embodiment of the present invention.

### BRIEF DESCRIPTION OF THE DRAWING

Embodiments of the invention will be described below purely by way of example with reference to the accompanying drawing and explanation of the technical background.

FIG. 1 illustrates a method or a system according to an embodiment not according to the invention.

FIG. 2 illustrates a method or a plant according to an embodiment of the present invention.

FIG. 3 illustrates the performance of a catalyst in an exemplary embodiment of the present invention.

### EMBODIMENTS OF THE INVENTION

The embodiments described below are described solely for the purpose of assisting the reader in understanding the features claimed and previously discussed. They are merely representative examples and are not intended to be considered to be exhaustive and/or limiting with respect to the features of the invention. It goes without saying that the advantages, embodiments, examples, functions, features, structures and/or other aspects described above and below are not to be considered to limit the scope of the invention as defined in the claims, or to limit equivalents to the claims, and that other embodiments may be used and changes made without departing from the scope of the claimed invention.

Different embodiments of the invention may comprise, have, consist of, or substantially consist of further expedient combinations of the described elements, components, features, parts, steps, means, etc., even if such combinations are not specifically described herein. Furthermore, the disclosure may comprise other inventions that are presently not claimed, but which may be claimed in the future, in particular when included in the scope of the independent claims.

Explanations relating to devices, apparatuses, arrangements, systems, etc. according to embodiments of the present invention may also apply to procedures, processes, methods, etc. according to the embodiments of the present invention, and vice versa. Elements, process steps, etc. that are identical, have the same effect, correspond in terms of their function, are structurally identical or have a similar structure can be indicated by identical reference signs.

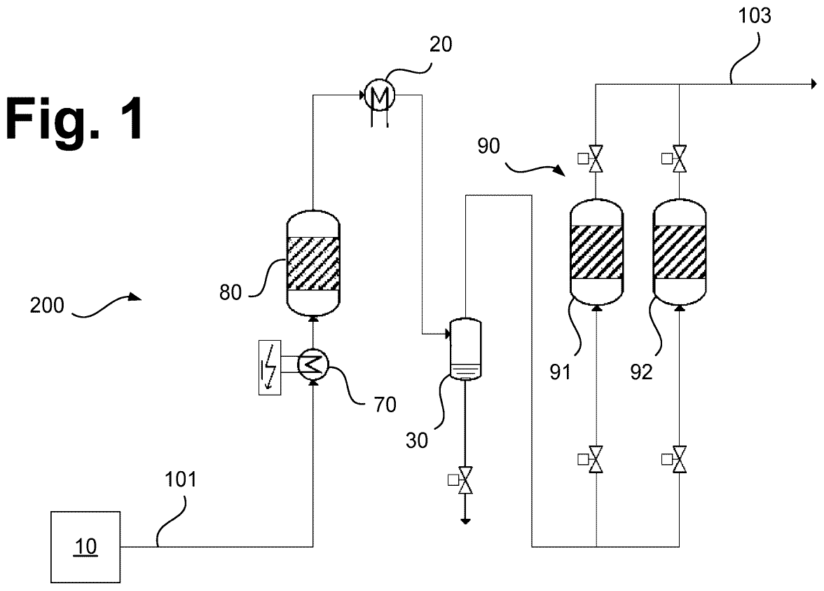

FIG. 1 illustrates a method or a system 200 according to an embodiment not according to the invention.

As illustrated here, a cathode gas 101 is provided using an electrolysis designated 10, in particular of the advantageous type explained above. This is heated in a heating device 70 before being fed to a catalytic reactor 80. As mentioned, the cathode gas 101 contains feed water and, downstream of the catalytic reactor 80, also oxidation water.

By cooling 20 the cathode gas 101, part of the water can be separated from it in a separator 140. The correspondingly partially dried cathode gas is finally dried in a pair of adsorber vessels 91, 92 in a drying unit 90. In this way, one obtains substantially oxygen-free, dried hydrogen 103.

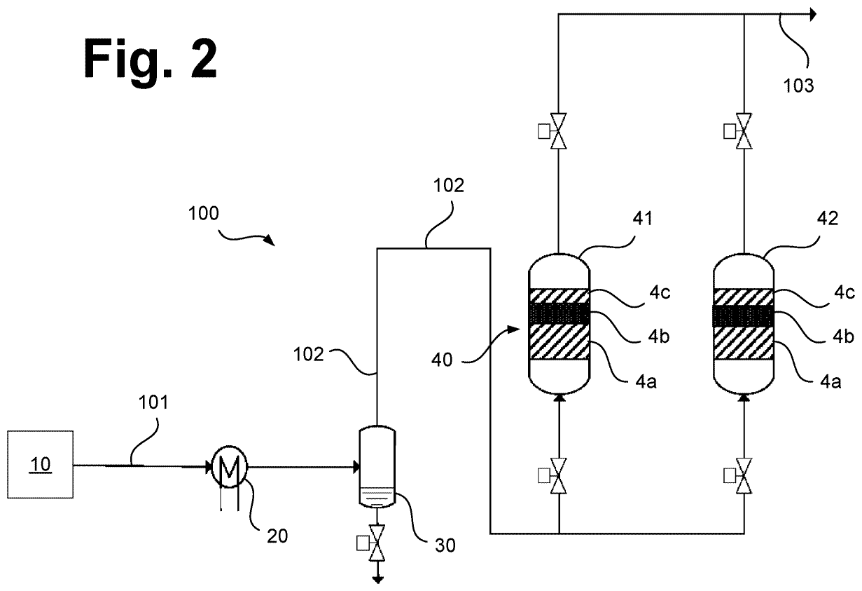

In FIG. 2, a method or a plant according to an embodiment of the present invention is shown and is designated as a whole by 100.

As shown in FIG. 2, in this embodiment, in a first step, the cathode gas 101 from the electrolysis 10 is cooled 20, in particular using cooling water and in the manner mentioned above, and then water is separated in a separator 30, whereby a process gas flow 102 is obtained. This is now alternately fed to two process units 41, 42 of a process arrangement 40. When fed into the process arrangement 40, the process gas flow 102 contains feed water but no oxidation water.

In the example illustrated here, each of the process units 41, 42 comprises a first adsorptive drying bed 4a, by means of which at least some of the feed water is removed from the process gas flow 102, a catalytic bed 4b arranged downstream of the first drying bed 4a, by means of which the catalytic conversion is carried out, and a second adsorptive drying bed 4c arranged downstream of the catalytic bed 4b, by means of which at least some of the oxidation water is removed from the process gas flow 102. With such an arrangement, at least part of the feed water can therefore initially be removed with the first drying bed 4a, so that the process gas flow 102 reaches the catalytic bed 4b substantially dry. The oxidation water can then be removed downstream.

In one exemplary embodiment, the performance of a catalyst for the catalytic conversion of oxygen of the type mentioned was investigated as a function of a hydrogen partial pressure and a gas hourly space velocity (GHSV).

A feed gas containing 23 volume percent hydrogen and 50 vppm oxygen in nitrogen was passed over 20 ml of an appropriate catalyst at 25° C. The hourly space velocity of the gas was increased from 14,000 to 55,000 h⁻¹ at three different system pressures (3.0, 4.8 and 10.0 bar absolute pressure). Assuming a hydrogen pressure of 20 to 30 bar for technical applications, a GHSV of over 50,000 h⁻¹ for hydrogen purification with an O2 content of 100 vppm in the raw hydrogen is realistic. Dryers have a GHSV of about 10,000 h⁻¹. The catalytic bed achieves an approximate increase of less than 20 volume percent of the total dryer volume.

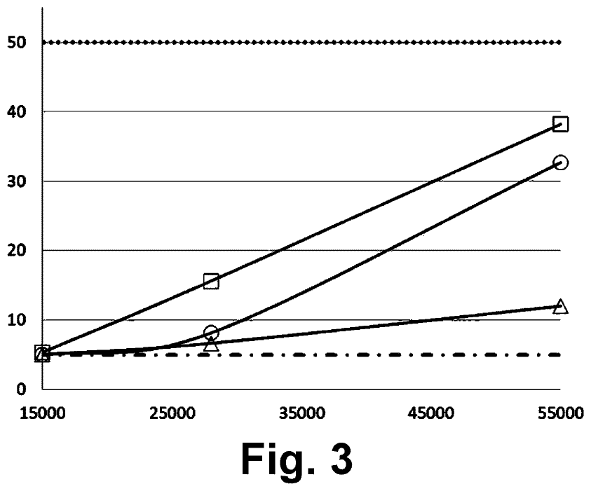

The results are shown in FIG. 3, which is a graph showing the hourly gas space velocity on the horizontal axis in dimensionless units per hour and an oxygen content in parts per million by volume on the vertical axis. The dotted line indicates the oxygen content in the supplied process gas flow; the dash-dotted line indicates a detection limit. The oxygen content is represented by square data points at a hydrogen partial pressure of 0.7 bar, by round data points at a hydrogen partial pressure of 1.1 bar, and by triangular data points at a hydrogen partial pressure of 2.3 bar.

The example proves that the catalyst provides satisfactory results for oxygen removal under dry conditions at high space velocities and even low hydrogen partial pressure at 25° C. Therefore, it is suitable for use in dryers for hydrogen cleaning.

1. Aethod for producing hydrogen, wherein feed water is subjected to electrolysis with a cathode gas being obtained, wherein the cathode gas contains hydrogen, oxygen and some of the feed water, wherein a process gas flow is formed using at least some of the cathode gas, wherein the process gas flow contains at least some of the hydrogen, oxygen and feed water contained in the cathode gas, and wherein, in the process gas flow, at least some of the oxygen is subjected to an oxidative catalytic reaction with some of the hydrogen to form oxidation water, and wherein at least some of the feed water and the oxidation water in the process gas flow are removed from the process gas flow in a water removal process, wherein the catalytic reaction and the water removal process are carried out using one or more process units, wherein the one process unit or each of the plurality of process units has a first adsorptive drying bed, by means of which at least some of the feed water is removed from the process gas flow, a catalytic bed which is arranged downstream of the first drying bed and by means of which the catalytic reaction is carried out, and a second adsorptive drying bed which is arranged downstream of the catalytic bed and by means of which at least some of the oxidation water is removed from the process gas flow.

2. The method according to claim 1, in which the process gas flow is supplied to the one or more process units at a feed temperature level of 10 to 50° C. and in particular at a feed pressure level of 10 to 40 bar above atmospheric pressure.

3. The method according to claim 2, in which the formation of the process gas flow comprises cooling the cathode gas or a portion thereof from a temperature level of between 50 and 80° C. to the feed temperature level and condensative separation of water.

4. The method according to claim 1, in which the process gas flow is provided in water-saturated form.

5. The method according to claim 1, in which the process gas flow is provided with an oxygen content of 20 to 500 parts per million by volume.

6. The method according to claim 1, in which the electrolysis is carried out as or comprises an alkaline electrolysis, and/or in which the electrolysis is carried out as or comprises an electrolysis using a proton exchange membrane.

7. The method according to claim 1, in which at least two of the process units are provided, through which the process gas flow or parts thereof flow cyclically.

8. The method according to claim 1, in which the first drying bed and the second drying bed comprise a material designed for adsorption drying.

9. The method according to claim 1, in which the water content in the process gas flow is reduced to a content of less than 100 parts per million by volume using the first drying bed.

10. A plant for producing hydrogen, wherein the plant is configured to subject feed water to electrolysis with a cathode gas being obtained, wherein the cathode gas contains hydrogen, oxygen, and some of the feed water, to form a process gas flow using at least some of the cathode gas, wherein the process gas flow contains at least some of the hydrogen, oxygen and feed water contained in the cathode gas, to subject at least some of the oxygen in the process gas flow to an oxidative catalytic conversion with some of the hydrogen to form oxidation water, and to remove at least some of the feed water and the oxidation water from the process gas flow in a water removal process, wherein the plant is configured to carry out the catalytic reaction and the water removal process using one or more process units, wherein the one process unit or each of the plurality of process units has a first adsorptive drying bed configured to remove at least some of the feed water from the process gas flow, a catalytic bed arranged downstream of the first drying bed and configured to carry out the catalytic conversion, and a second adsorptive drying bed arranged downstream of the catalytic bed and configured to remove at least some of the oxidation water from the process gas flow.

11. The plant for producing hydrogen, wherein the plant is configured to subject feed water to electrolysis with a cathode gas being obtained, wherein the cathode gas contains hydrogen, oxygen, and some of the feed water, to form a process gas flow (using at least some of the cathode gas, wherein the process gas flow contains at least some of the hydrogen, oxygen and feed water contained in the cathode gas, to subject at least some of the oxygen in the process gas flow to an oxidative catalytic conversion with some of the hydrogen to form oxidation water, and to remove at least some of the feed water and the oxidation water from the process gas flow in a water removal process, wherein that the plant is configured to carry out the catalytic reaction and the water removal process using one or more process units, wherein the one process unit or each of the plurality of process units has a first adsorptive drying bed configured to remove at least some of the feed water from the process gas flow, a catalytic bed arranged downstream of the first drying bed and configured to carry out the catalytic conversion, and a second adsorptive drying bed arranged downstream of the catalytic bed and configured to remove at least some of the oxidation water from the process gas flow, which is configured to carry out a method according to claim 1.

12. The method according to claim 2, in which the process gas flow is provided in water-saturated form.

13. The method according to claim 3, in which the process gas flow is provided in water-saturated form.

14. The method according to claim 2, in which the process gas flow is provided with an oxygen content of 20 to 500 parts per million by volume.

15. The method according to claim 3, in which the process gas flow is provided with an oxygen content of 20 to 500 parts per million by volume.

16. The method according to claim 4, in which the process gas flow is provided with an oxygen content of 20 to 500 parts per million by volume.

17. The method according to claim 2, in which the electrolysis is carried out as or comprises an alkaline electrolysis, and/or in which the electrolysis is carried out as or comprises an electrolysis using a proton exchange membrane.

18. The method according to claim 3, in which the electrolysis is carried out as or comprises an alkaline electrolysis, and/or in which the electrolysis is carried out as or comprises an electrolysis using a proton exchange membrane.

19. The method according to claim 4, in which the electrolysis is carried out as or comprises an alkaline electrolysis, and/or in which the electrolysis is carried out as or comprises an electrolysis using a proton exchange membrane.

20. The method according to claim 5, in which the electrolysis is carried out as or comprises an alkaline electrolysis, and/or in which the electrolysis is carried out as or comprises an electrolysis using a proton exchange membrane.
